(19) United States
(12) Patent Application Publication
(10) Pub. No.: US 2014/0349623 A1
(43) Pub. Date: Nov. 27, 2014

(54) METHOD AND APPARATUS FOR ALERTING HARASSING PHONE NUMBERS

(71) Applicant: Tencent Technology (Shenzhen) Company Limited, Shenzhen (CN)

(72) Inventors: Yuejiao HOU, Shenzhen (CN); Yinghua YE, Shenzhen (CN); Hong LI, Shenzhen (CN); Na SHAO, Shenzhen (CN)

(73) Assignee: Tencent Technology (Shenzhen) Company Limited, Shenzhen (CN)

(21) Appl. No.: 14/198,406

(22) Filed: Mar. 5, 2014

Related U.S. Application Data
(63) Continuation of application No. PCT/CN2013/088524, filed on Dec. 4, 2013.

(30) Foreign Application Priority Data
May 27, 2013 (CN) 201310201799.6

(51) Int. Cl. H04M 3/436; H04W 4/16

(52) U.S. Cl. CPC H04M 3/436; H04W 4/16
USPC 455/414.1

(57) ABSTRACT

A computer-implemented method is performed at a mobile device having one or more processors and memory and a display. Upon receiving an incoming call from a phone number, the mobile device determines whether the phone number is deemed to be a harassing phone number. If so, the mobile device retrieves information associated with the harassing phone number. After detecting that the incoming call is terminated without being answered, the mobile device marks the incoming call as a missed call. In response to a user request for viewing the missed call, the mobile device displays the harassing phone number and at least a portion of the retrieved information adjacent the harassing phone number on the display.

### RELATED APPLICATIONS

This application is a continuation application of PCT Patent Application No. PCT/CN2013/088524, entitled “METHOD AND APPARATUS FOR ALERTING HARASSING PHONE NUMBERS” filed on Dec. 4, 2013, which claims priority to Chinese Patent Application No. 201310201799.6, “METHOD AND APPARATUS FOR ALERTING HARASSING PHONE NUMBERS,” filed on May 27, 2013, both of which are hereby incorporated by reference in their entirety

### FIELD OF THE INVENTION

The present application relates to the field of mobile communications, and more particularly, to a method and an apparatus for prompting harassing phone numbers.

### BACKGROUND OF THE INVENTION

With rapid development of mobile communication technologies, mobile phones have become requisites of lots of modern men' life and work, but the mobile phones bring a hidden trouble to people's lives while bringing convenience to people. Harassing phone call is one of the hidden trouble, and the harassing phone call seriously affects people's normal life, and thus prompting harassing phone numbers corresponding to the harassing phone calls to the user can avoid affecting people's normal life.

Currently, security-class application can be installed on the mobile phone, and whether phone numbers corresponding to the received phone calls are harassing phone numbers can be identified through the security-class application, and the user is prompted. The security-class application, when the mobile phone receives a phone call from a caller, identifies whether the phone number corresponding to the phone call is a harassing phone number, and displays prompt information on an incoming call interface of the phone call to prompt the user. It should be noted that, if the user does not answer the phone call, the prompt information displayed on the incoming call interface may disappear with the incoming call interface when the call is hanged up, and the mobile phone uses the phone call as a missed call to be stored in a missed call display interface.

Currently, the user usually opens the missed call display interface, and dials the missed call in the missed call display interface, or, the user usually inputs a phone number to the mobile phone and dials the phone number, if the phone number corresponding to the dialed missed call or the phone number input by the user is a harassing phone number, it may bring about economic loss to the user.

### SUMMARY

In order to address the problems in the prior art, the embodiments of the present invention provide a method and mobile device for processing missed calls from and outgoing calls to harassing phone numbers.

In some embodiments, a computer-implemented method is performed at a mobile device having one or more processors and memory and a display. Upon receiving an incoming call from a phone number, the mobile device determines whether the phone number is deemed to be a harassing phone number. If so, the mobile device retrieves information associated with the harassing phone number. After detecting that the incoming call is terminated without being answered, the mobile device marks the incoming call as a missed call. In response to a user request for viewing the missed call, the mobile device displays the harassing phone number and at least a portion of the retrieved information adjacent the harassing phone number on the display.

In some embodiments, a mobile device comprises one or more processors; memory; a display; and one or more programs stored in the memory and to be executed by the one or more processors, the one or more programs comprising instructions for: receiving an incoming call from a phone number; in accordance with a determination that the phone number is a harassing phone number, retrieving information associated with the harassing phone number; after detecting that the incoming call is terminated without being answered, marking the incoming call as a missed call; and in response to a user request for viewing the missed call, displaying the harassing phone number and at least a portion of the retrieved information adjacent the harassing phone number on the display.

In some embodiments, a non-transitory computer readable storage medium stores one or more programs, the one or more programs comprising instructions, which, when executed by a mobile device having one or more processors and a display, cause the mobile device to perform operations including: receiving an incoming call from a phone number; in accordance with a determination that the phone number is a harassing phone number, retrieving information associated with the harassing phone number; after detecting that the incoming call is terminated without being answered, marking the incoming call as a missed call; and in response to a user request for viewing the missed call, displaying the harassing phone number and at least a portion of the retrieved information adjacent the harassing phone number on the display.

### BRIEF DESCRIPTION OF THE DRAWINGS

The aforementioned features and advantages of the invention as well as additional features and advantages thereof will be more clearly understood hereinafter as a result of a detailed description of preferred embodiments when taken in conjunction with the drawings.

FIG. 1 is a flow chart of a method for prompting harassing phone numbers according to Embodiment 1 of the present application;

FIG. 2 is a flow chart of a method for prompting harassing phone numbers according to Embodiment 2 of the present application;

FIG. 3 is a schematic structural diagram of an apparatus for prompting harassing phone numbers according to Embodiment 3 of the present application; and

FIG. 4 is a schematic structural diagram of another apparatus for prompting harassing phone numbers according to Embodiment 3 of the present application.

FIG. 5A is a block diagram of an exemplary screenshot depicting information related to different types of incoming calls according to some embodiments of the present application.

FIG. 5B is a block diagram of an exemplary screenshot depicting information related to an outgoing call to a potentially harassing phone number according to some embodiments of the present application.

FIG. 5C is a block diagram of an exemplary screenshot depicting information related to an outgoing call to a potentially harassing phone number according to some embodiments of the present application.

FIG. 6 is a block diagram of a mobile device for blocking harassing phone calls according to some embodiments of the present application.

Like reference numerals refer to corresponding parts throughout the several views of the drawings.

### DESCRIPTION OF EMBODIMENTS

Reference will now be made in detail to embodiments, examples of which are illustrated in the accompanying drawings. In the following detailed description, numerous specific details are set forth in order to provide a thorough understanding of the subject matter presented herein. But it will be apparent to one skilled in the art that the subject matter may be practiced without these specific details. In other instances, well-known methods, procedures, components, and circuits have not been described in detail so as not to unnecessarily obscure aspects of the embodiments.

To make the objectives, technical solutions, and advantages of the present application comprehensible, embodiments of the present application are further described in detail below with reference to the accompanying drawings.

### Embodiment 1

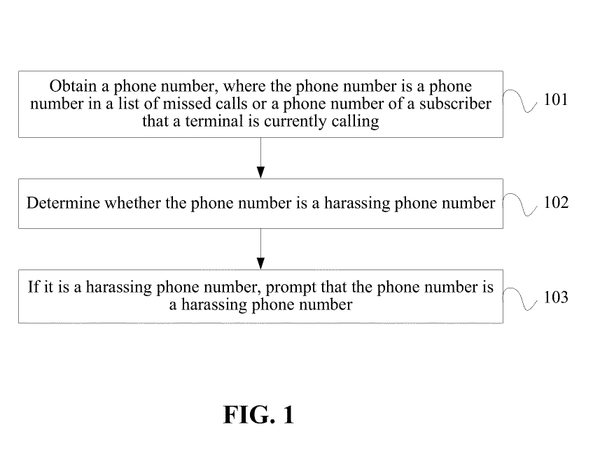

This embodiment of the present application provides a method for prompting harassing phone numbers. Referring to FIG. 1, the method includes the following steps.

101: Obtain a phone number, where the phone number is a phone number in a list of missed calls or a phone number of a subscriber that a terminal is currently calling.

102: Determine whether the phone number is a harassing phone number.

103: If it is a harassing phone number, prompt that the phone number is a harassing phone number.

The prompting that the phone number is a harassing phone number includes:

prompting that the phone number is a harassing phone number on a missed call display interface of the terminal; or

prompting that the phone number is a harassing phone number on a call display interface wherein the phone number is called.

In this embodiment of the present application, obtain a phone number, wherein the phone number is a phone number in a list of missed calls or a phone number of a subscriber that a terminal is currently calling; according to the phone number, determine whether the phone number is a harassing phone number, and if it is a harassing phone number, prompt that the phone number is a harassing phone number on a missed call display interface of a terminal; or, prompt that the phone number is a harassing phone number on a call display interface wherein the phone number is called, so as to avoid the problem of bringing about economic loss to the user due to dialing the phone number without understanding the background of the phone number if the phone number is a harassing phone number.

### Embodiment 2

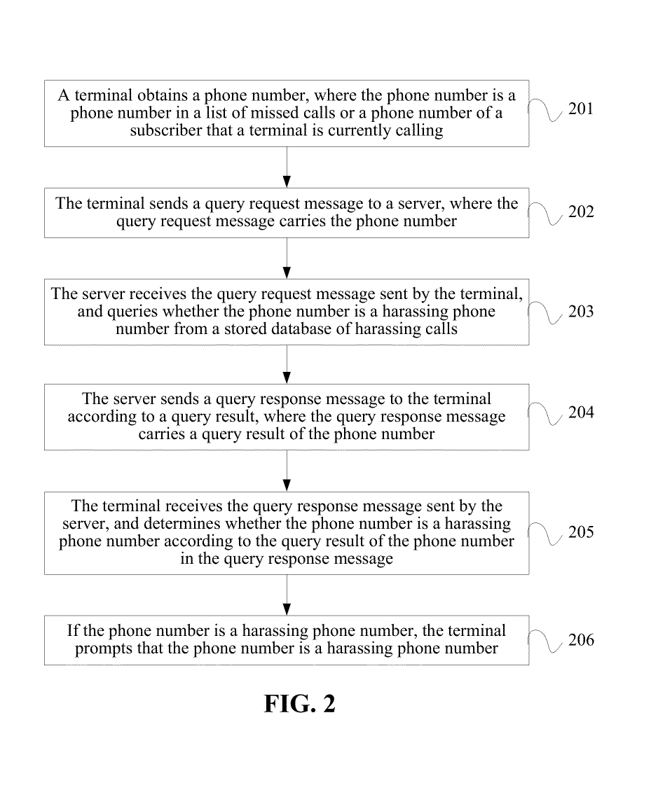

This embodiment of the present application provides a method for prompting harassing phone numbers. Referring to FIG. 2, the method includes the following steps.

201: A terminal obtains a phone number, where the phone number is a phone number in a list of missed calls or a phone number of a subscriber that a terminal is currently calling.

The list of missed calls includes all phone numbers in a missed call display interface of the terminal.

The operation that a terminal obtains a phone number may be as follows: obtain phone numbers of missed calls not existing in a contact directory of the terminal from a list of missed calls; or, determine whether the phone number in a call display interface of the terminal is a phone number in the contact directory of the terminal, and if no, obtain the phone number in the call display interface of the terminal.

Before the terminal obtains the phone number, the terminal judges whether a phone number in the list of missed calls exists in the contact directory of the terminal, and if the phone number exists in the contact directory of the terminal, the terminal does not obtain the phone number; if the phone number does not exist in the contact directory of the terminal, the terminal obtains the phone number; or, the terminal judges whether a phone number on a call display interface that the terminal is currently calling exists in the contact directory of the terminal, and if the phone number exists in the contact directory of the terminal, the terminal does not obtain the phone number; if the phone number does not exist in the contact directory of the terminal, the terminal obtains the phone number.

If the phone number exists in the contact directory of the terminal, the phone number is a phone number of the contact that the user knows, and it is determined that the phone number is not a harassing phone number; if the phone number does not exist in the contact directory of the terminal, the phone number may be a harassing phone number.

When the user opens the missed call display interface, the terminal obtains phone numbers of missed calls in the list of missed calls. When the user calls the phone numbers of missed calls in the list of missed calls, the terminal obtains a phone number of a missed call that the terminal is currently calling. When the user inputs the phone number of the call and submits a call command to the terminal, the terminal receives the call command submitted by the user, opens the call display interface, and obtains the phone number of the call in the call display interface.

The terminal may be any terminal having a communication function, for example, mobile phones and the like; the phone number of the missed call or the phone number of the call may be a mobile phone number, a telephone number or a network IP (Internet Protocol, protocol of interconnection between networks) phone number. The missed call display interface refers to an interface displaying missed calls; and the call display interface refers to an interface displaying calls.

202: The terminal sends a query request message to a server, where the query request message carries the phone number.

The server may be a server having a number query function disposed at a network side, a database of harassing calls is stored in the server, the database of harassing calls is at least partially used for storing phone numbers of harassing calls, and may be further used for storing attribute information of harassing phone numbers, the attribute information of harassing phone numbers includes types of the harassing phone numbers and/or calling regions of the harassing phone numbers and other information, and the types of the phone numbers include telemarketing calls, intermediary calls or customer service calls.

The harassing phone numbers and the attribute information of harassing phone numbers stored in the database of harassing calls may be collected by network operators which store the collected harassing phone numbers and attribute information of harassing phone numbers in the database of harassing calls of the server, or be collected by the public security organs which store the collected harassing phone numbers and attribute information of harassing phone numbers in the database of harassing calls of the server, or be collected by user terminals which send the collected harassing phone numbers and attribute information of harassing phone numbers to the server, and the server stores them into the database of harassing calls.

The query request message is used for querying whether the missed phone number or call number is a harassing phone number.

203: The server receives the query request message sent by the terminal, and queries whether the phone number is a harassing phone number from the stored database of harassing calls.

Specifically, the server receives the query request message sent by the terminal, obtains the phone number carried in the query request message, queries whether the phone number is stored in the database of harassing calls from the stored database of harassing calls, and if the phone number is stored in the database of harassing calls, queries that the phone number is a harassing phone number; if the phone number is not stored in the database of harassing calls, queries that the phone number is not a harassing phone number.

204: The server sends a query response message to the terminal according to a query result, wherein the query response message carries a query result of the phone number.

The query result includes the phone number being a harassing phone number or the phone number not being a harassing phone number.

The server sends a query response message to the terminal according to a query result, if the phone number is a harassing phone number, the query response message carries a query result of the phone number, and the query result is that the phone number is a harassing phone number; if the phone number is not a harassing phone number, the query response message carries a query result of the phone number, and the query result is that the phone number is not a harassing phone number.

If the phone number is a harassing phone number, the server obtains attribute information of the phone number from the stored database of harassing calls according to the phone number.

Further, if the phone number is a harassing phone number, the query response message may further carry attribute information of the phone number.

The query response message carries attribute information of a phone number of the missed call, so as to enable the user to directly understand the background of the phone number, thereby not causing economic loss by dialing the phone number due to not understanding the background of the phone number.

For example, when the user opens the missed call display interface, the terminal obtains a phone number 123456 of the missed call in the list of missed calls, and sends a query request message to the server, and the query request message carries the phone number 123456 of the missed call. The server receives the query request message sent by the terminal, obtains the phone number 123456 of the missed call according to the query request message, and queries the phone number of the missed call from the stored database of harassing calls according to the phone number 123456 of the missed call. Suppose the phone number 123456 of the missed call is stored in the database of harassing calls, query that the missed phone number is a harassing phone number; the server sends a query response message to the terminal according to the query result, the query response message carries that the phone number 123456 of the missed call is a harassing phone number, and the query response message may further carry attribute information of the missed phone number 123456. The attribute information of the missed phone number 123456 includes the type of the missed phone number 123456: telemarketing call, and the attribute information of the missed phone number 123456 further includes the calling region of the missed phone number 123456: Beijing.

205: The terminal receives the query response message sent by the server, and determines whether the phone number is a harassing phone number according to the query result of the phone number in the query response message.

Specifically, the terminal receives the query response message sent by the server, obtains a query result of the phone number carried in the query response message, when the query result is that the phone number is a harassing phone number, determines that the phone number is a harassing phone number; and when the query result is that the phone number is not a harassing phone number, determines that the phone number is not a harassing phone number.

206: If the phone number is a harassing phone number, the terminal prompts that the phone number is a harassing phone number.

The operation of prompting that the phone number is a harassing phone number may be as follows.

(1) Display text information used for prompting that the phone number is a harassing phone number, for example, the text information may be: “** is a harassing phone number.” “**” is the phone number.

(2) Display icon information used for prompting that the phone number is a harassing phone number, for example, “O” is used to indicate that the phone number is a harassing phone number.

(3) Play voice information used for prompting that the phone number is a harassing phone number, for example, the voice information may be: “** is a harassing phone number.”“**” is the phone number.

When the user opens the missed call display interface, if the phone number of the missed call is a harassing phone number, prompt that the phone number of the missed call is a harassing phone number on the missed call display interface.

Specifically, if the phone number of the missed call is a harassing phone number, display text information used for prompting that the phone number is a harassing phone number on the missed call display interface; or, display icon information used for prompting that the phone number is a harassing phone number on the missed call display interface; or, play voice information used for prompting that the phone number is a harassing phone number.

When the terminal receives a call command submitted by the user, the terminal opens the call display interface, if the phone number of the call is a harassing phone number, prompt that the phone number of the call is a harassing phone number on the call display interface.

Specifically, when the user dials the phone number of the call, the user inputs the phone number of the call to the terminal, and submits a call command. The terminal receives the call command submitted by the user, opens the call display interface, and if the phone number of the call is a harassing phone number, displays text information used for prompting that the phone number is a harassing phone number on the call display interface where the call is made; or, displays icon information used for prompting that the phone number is a harassing phone number on the call display interface where the call is made; or, plays voice information displays text information used for prompting that the phone number is a harassing phone number.

The call display interface refers to a display interface where the missed call is made but has not been answered by the other side.

Further, if the phone number is a harassing phone number and the query response message carries attribute information of the phone number, the prompting that the phone number is a harassing phone number may be as follows.

When the phone number is a phone number of a missed call, display attribute information of the missed call on the missed call display interface, or, play voice information containing attribute information of the phone number of the missed call on the missed call display interface; when the phone number is a phone number of a subscriber that the terminal is currently calling, display attribute information of the call on the call display interface, or, play voice information containing attribute information of the phone number of the call on the call display interface.

Further, if the phone number is not a harassing phone number, display on the missed call display interface or call display interface according to requirements of the terminal system.

Further, when it is determined that the phone number is not a harassing phone number, if a command input by the user used for reporting the phone number is received, report the phone number to the server, so that the server adds the phone number to the database of harassing calls.

Specifically, when the terminal determines that the phone number is not a harassing phone number, when the user determines that the phone number is a harassing phone number, the user inputs to the terminal a command for reporting that the phone number is a harassing phone number, and the terminal receives the command input by the user for reporting that the phone number is a harassing phone number, and reports the phone number to the server.

The server receives report of the terminal, and adds the phone number to the database of harassing calls when determining that report of the phone number from different terminals above a preset number.

The terminal reports the operation of the missed call to the server, which may be as follows.

The terminal sends alarm information to the server, wherein the alarm information at least carries the phone number; and the alarm information may further carry attribute information of the phone number.

If the alarm information carries attribute information of the phone number, the server receives the alarm information sent by the terminal, obtains the phone number and the attribute information of the phone number according to the alarm information, and stores a correspondence relationship between the phone number and the attribute information of the phone number in the database of harassing calls.

For example, the terminal judges that the phone number 123456 is not a harassing phone number, when the user connects the phone number 123456 and determines that the phone number 123456 is a harassing phone number, the user inputs to the terminal a command for reporting that the phone number 123456 is a harassing phone number, the terminal receives the command input by the user for reporting that the phone number 123456 is a harassing phone number, and sends alarm information to the server, and the alarm information carries the phone number 123456 and attribute information of the phone number: Beijing telemarketing call. The server receives the alarm information sent by the terminal, and obtains the phone number 123456 and the attribute information of the phone number carried by the alarm information: Beijing telemarketing call, and when the server receives the alarm information carrying the phone number 123456 sent by different terminals above a preset number, the server stores a correspondence relationship between the phone number 123456 and the attribute information of the phone number: Beijing telemarketing call, into the database of harassing calls.

In this embodiment of the present application, obtain a phone number, wherein the phone number is a phone number in a list of missed calls or a phone number of a subscriber that a terminal is currently calling; according to the phone number, determine whether the phone number is a harassing phone number, and if it is a harassing phone number, prompt that the phone number is a harassing phone number on a missed call display interface of a terminal; or, prompt that the phone number is a harassing phone number on a call display interface wherein the phone number is called, so as to avoid the problem of bringing about economic loss to the user due to dialing the phone number without understanding the background of the phone number if the phone number is a harassing phone number.

### Embodiment 3

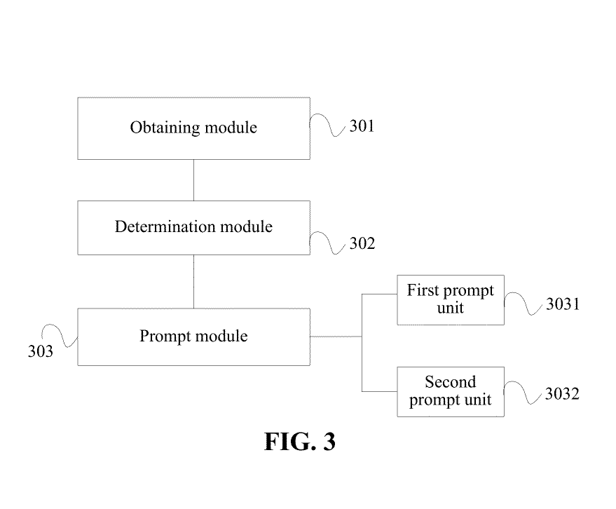

This embodiment of the present application provides an apparatus for prompting harassing phone numbers. Referring to FIG. 3, the apparatus includes:

an obtaining module 301, used for obtaining a phone number, wherein the phone number is a phone number in a list of missed calls or a phone number of a subscriber that a terminal is currently calling;

a determination module 302, used for determining that the phone number is a harassing phone number; and

a prompt module 303, used for, if the determination module determines that the phone number is a harassing phone number, prompting that the phone number is a harassing phone number.

The prompt module 303 includes:

a first prompt unit 3031, used for prompting that the phone number is a harassing phone number on a missed call display interface of a terminal; and

a second prompt unit 3032, used for prompting that the phone number is a harassing phone number on a call display interface where the phone number is called.

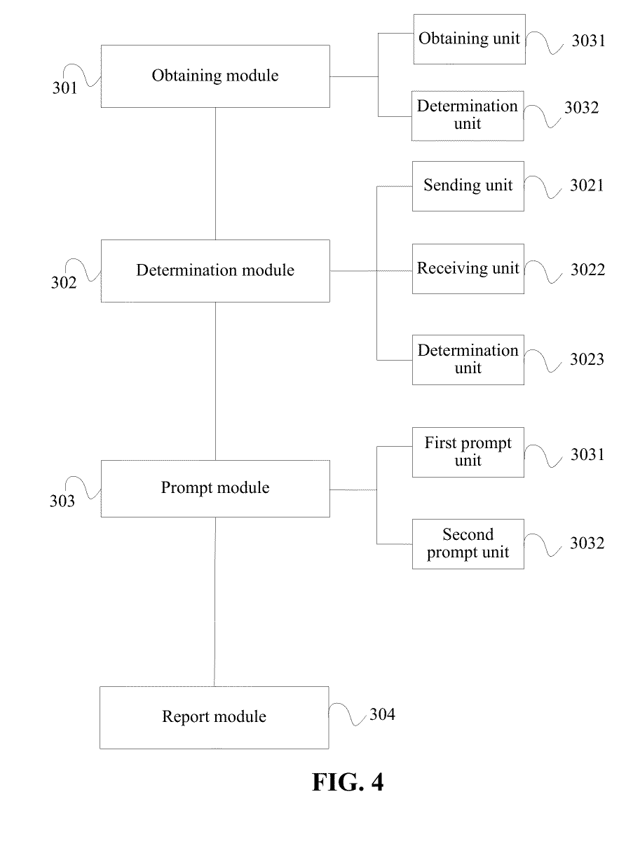

Further, this embodiment of the present application provides an apparatus for prompting harassing phone numbers. Referring to FIG. 4, in addition to the obtaining module 301, the determination module 302 and the prompt module 303, the determination module 302 further includes:

a sending unit 3021, used for sending a query request message to a server, wherein the query request message carries the phone number, so that the server queries whether the phone number is a harassing phone number from the stored database of harassing calls, and the database of harassing calls is used for storing harassing phone numbers;

a receiving unit 3022, used for receiving the query request message sent by the server, wherein the query request message carries a query result of the phone number; and

a determination unit 3023, used for determining whether the phone number is a harassing phone number according to the query result of the phone number.

Further, the apparatus further includes: a reporting module 304, used for, when determining that the phone number is not a harassing phone number, reporting the phone number to the server if receiving a command input by the user for reporting the phone number, so that the server adds the phone number into the database of harassing calls.

Further, the obtaining module 301 includes:

an obtaining unit 3011, used for obtaining phone numbers of missed calls not existing in a contact directory of the terminal from a list of missed calls; and

a determination unit 3012, used for determining whether the phone number in a call display interface of the terminal is a phone number in the contact directory of the terminal.

The obtaining unit 3011 is further used for, if the determination unit 3012 determines that the phone number is not a phone number in the contact directory of the terminal, obtaining the phone number in the call display interface of the terminal.

In this embodiment of the present application, obtain a phone number, wherein the phone number is a phone number in a list of missed calls or a phone number of a subscriber that a terminal is currently calling; according to the phone number, determine whether the phone number is a harassing phone number, and if it is a harassing phone number, prompt that the phone number is a harassing phone number on a missed call display interface of a terminal; or, prompt that the phone number is a harassing phone number on a call display interface wherein the phone number is called, so as to avoid the problem of bringing about economic loss to the user due to dialing the phone number without understanding the background of the phone number if the phone number is a harassing phone number.

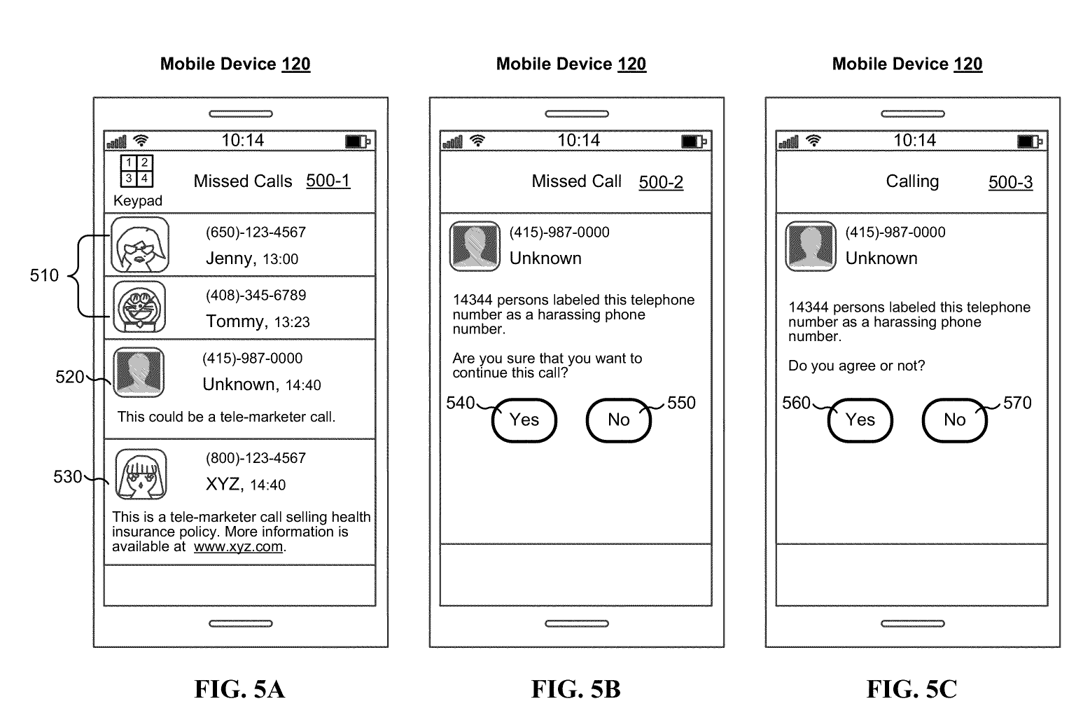

FIG. 5A is a block diagram of an exemplary screenshot depicting information related to different types of incoming calls according to some embodiments of the present application.

In this example, the screenshot 500-1 depicts a list of missed calls. In other words, an incoming call arrives at the mobile device 120 but a user of the mobile device 120 fails to answer the call, which is then marked as a missed call. For each missed call, the mobile device 120 may need to perform additional operations. For example, the mobile device identifies a phone number associated with the missed call and compares the phone number with its contact list. If the phone number matches an entry in the contact list, additional information (such as a user's name associated with the phone number) is displayed next to the phone number in the missed call list. For example, the first two entries 510 in the screenshot 500-1 represent two missed calls from two persons who are present in the mobile device 120's contact list.

If the mobile device 120 cannot find a matching entry in the contact list, the mobile device 120 may make further investigation as to whether the incoming call is from a harass phone number. For example, the mobile device 120 may compare the phone number with a list of harass phone numbers stored in the mobile device 120 (e.g., its memory). If a match is found, the mobile device 120 then retrieves information associated with the harassing phone number, at least part of which will be displayed to the user of the mobile device 120 when the user visits the missed calls list. In some embodiments, the mobile device 120 may submit a query to a remote server for determining whether the incoming call is from a harassing phone number or not. As noted above, the remote server may maintain a database of harassing phone numbers and their associated information. In response to the query, the remote server determines whether the phone number associated with the incoming call is a harassing phone number or not and then provide a response accordingly. Using the information provided by the remote server, the mobile device then determines what information is to be displayed adjacent the phone number in the missed calls list.

As shown in FIG. 5A, there are two missed calls from tele-marketers (which are usually deemed as harassing calls). In particular, the missed call 520 is from a unknown source. Therefore, the entry 520 only includes information that this missed call could be a tele-marketer call. But there is no additional information. The missed call 530 is from a known tele-marketer. In this case, the entry includes not only a name of the tele-marketer “XYZ” but also its own icon (e.g., its logo) and the nature of the tele-marketer's business and a link to a website associated with the tele-marketer www.xyz.com. In some embodiments, the mobile device 120 retrieves different types of information associated with a harassing phone number but also depicts a portion of the information in the missed calls list, e.g., to save space for other missed calls. The user can select a particular entry to view more information associated with the corresponding missed call. In some embodiments, the tele-marketer “XYZ” registers its advertising service with the remote server, which then offers information provided by the tele-marketer to the mobile device 120 that receives a call from the tele-marketer and then pulls information about the tele-marketer from the remote server. In this case, the mobile device 120 may not generate any ringtone but automatically place the call in the missed call list so that the user can subsequently see the call from the tele-marketer by visiting the missed calls list.

Assuming that the user wants to know about the missed call 520, he or she can select the corresponding entry. In response, the mobile device 120 presents a new screenshot 500-2 as shown in FIG. 5B. Since this screenshot is about one missed call, the mobile device 120 may present additional information related to the phone number. In this case, the additional information indicates the number of users who have labeled the telephone number as a harassing phone number. For example, the remote server collects opinions about a particular phone number from a large number of users and determines whether the phone number is harassing or not based on the survey result. In addition, the screenshot 500-2 includes a plurality of options for the user to choose. In response to a user selection of one of the options, the mobile device 120 performs an operation associated with the user-selected option accordingly. For example, if the user wants to place a call to the phone number associated with the missed call, he or she can press the “Yes” button 540. In response to a user selection to place a call to the harassing phone number, the mobile device 120 may initiate the call to the phone number and remove the phone number from a list of harassing phone numbers such that no harassing-alert information is displayed in response to future incoming, missed, or outgoing calls associated with the phone number. This is based on the assumption that the user will not place a call to a harassing phone number.

Otherwise, he or she can place the “No” button 550. By doing so, the user may indicate that the phone number should be labeled as a harassing phone number. In response, the mobile device 120 adds the phone number to a list of harassing phone numbers such that no ringtone is generated in response to future incoming calls from the phone number.

In some embodiments (as shown in FIG. 5C), after the user places the call to the harassing phone number and while conducting the call, the mobile device may display one or more options for the user to label the phone number as a harassing phone number on the display. This situation may happen when the user is not aware of the nature of the harassing phone number before placing the call but changes his or her mind after talking to the representative on the other end of the call. In this case, the user can choose the “Yes” button 560 to indicate that he or she agrees with others that this is indeed a harassing phone number. In response to the user selection, the mobile device 120 submits a request including the phone number to the remote server, which then updates a number of times the phone number is marked as a harassing phone number in accordance with the user request. If the user selects the “No” button 570, the mobile device 120 then remove the phone number from a list of harassing phone numbers such that no harassing-alert information is displayed in response to future incoming, missed, or outgoing calls associated with the phone number.

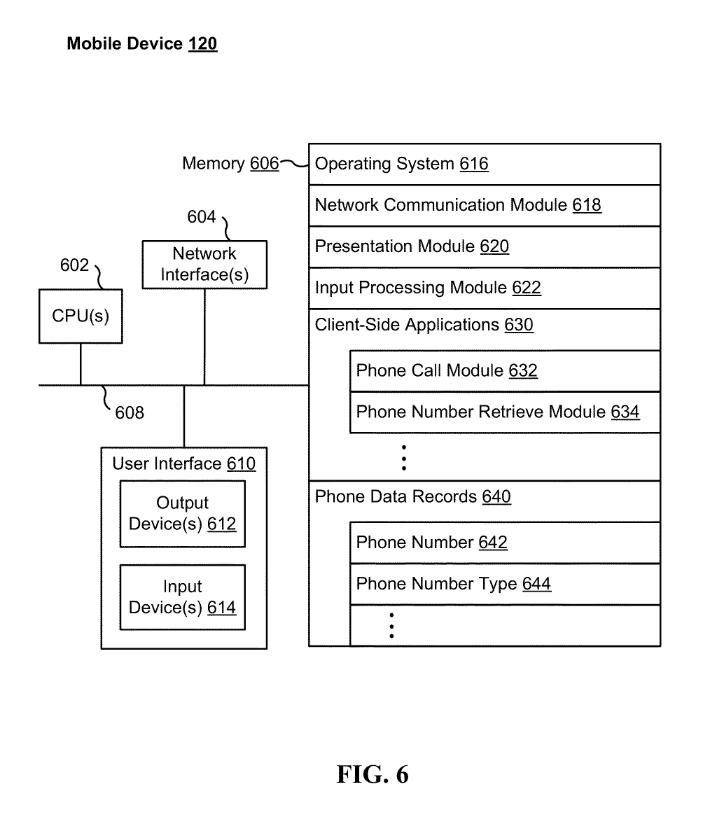

FIG. 6 is a block diagram of a mobile device 120 for blocking harassing phone calls according to some embodiments of the present application. Client device 120, typically, includes one or more processing units (CPUs) 602, one or more network interfaces 604, memory 606, and one or more communication buses 608 for interconnecting these components (sometimes called a chipset). Client device 120 also includes a user interface 610. User interface 610 includes one or more output devices 612 that enable presentation of media content, including one or more speakers and/or one or more visual displays. User interface 610 also includes one or more input devices 614, including user interface components that facilitate user input such as a keyboard, a mouse, a voice-command input unit or microphone, a touch screen display, a touch-sensitive input pad, a gesture capturing camera, or other input buttons or controls. Furthermore, some client devices 120 use a microphone and voice recognition or a camera and gesture recognition to supplement or replace the keyboard. Memory 606 includes high-speed random access memory, such as DRAM, SRAM, DDR RAM, or other random access solid state memory devices; and, optionally, includes non-volatile memory, such as one or more magnetic disk storage devices, optical disk storage devices, flash memory devices, or other non-volatile solid state storage devices. Memory 606, optionally, includes one or more storage devices remotely located from one or more processing units 602. Memory 606, or alternatively the non-volatile memory device(s) within memory 606, includes a non-transitory computer readable storage medium. In some embodiments, memory 606, or the non-transitory computer readable storage medium of memory 606, stores the following programs, modules, and data structures, or a subset or superset thereof:

operating system 616 including procedures for handling various basic system services and for performing hardware dependent tasks;

network communication module 618 for connecting client device 120 to other computing devices (e.g., server system 140) connected to one or more networks 115 via one or more network interfaces 604 (wired or wireless);

presentation module 620 for enabling presentation of information (e.g., a user interface for a widget, webpage, or an application, audio and/or video content, text, etc.) at client device 120 via one or more output devices 612 (e.g., displays, speakers, etc.) associated with user interface 610; and

input processing module 622 for detecting one or more user inputs or interactions from one of the one or more input devices 614 and interpreting the detected input or interaction.

In some embodiments, memory 606 also includes one or more client-side applications 630 for performing client-side data processing for the information exchange program (e.g., a phone call or a query submitted to a remote server). Client-side applications 630 includes, but is not limited to:

phone call module 632 for processing incoming, outgoing, and missed calls as described above; and

phone number retrieve module 634 for retrieving information related to a phone number locally or from a remote server as described above.

In some embodiments, memory 606 also includes one or more phone data records 640 for storing data related to different phone numbers associated with the incoming, outgoing, and missed calls at the mobile device 120, each phone record including a phone number 642 and a phone number type 644 (e.g., harassing phone number or friend's phone number).

Each of the above identified elements may be stored in one or more of the previously mentioned memory devices, and corresponds to a set of instructions for performing a function described above. The above identified modules or programs (i.e., sets of instructions) need not be implemented as separate software programs, procedures, modules or data structures, and thus various subsets of these modules may be combined or otherwise re-arranged in various implementations. In some embodiments, memory 606, optionally, stores a subset of the modules and data structures identified above. Furthermore, memory 606, optionally, stores additional modules and data structures not described above.

While particular embodiments are described above, it will be understood it is not intended to limit the invention to these particular embodiments. On the contrary, the invention includes alternatives, modifications and equivalents that are within the spirit and scope of the appended claims. Numerous specific details are set forth in order to provide a thorough understanding of the subject matter presented herein. But it will be apparent to one of ordinary skill in the art that the subject matter may be practiced without these specific details. In other instances, well-known methods, procedures, components, and circuits have not been described in detail so as not to unnecessarily obscure aspects of the embodiments.

The terminology used in the description of the invention herein is for the purpose of describing particular embodiments only and is not intended to be limiting of the invention. As used in the description of the invention and the appended claims, the singular forms “a,”“an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,”“including,”“comprises,” and/or “comprising,” when used in this specification, specify the presence of stated features, operations, elements, and/or components, but do not preclude the presence or addition of one or more other features, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

Although some of the various drawings illustrate a number of logical stages in a particular order, stages that are not order dependent may be reordered and other stages may be combined or broken out. While some reordering or other groupings are specifically mentioned, others will be obvious to those of ordinary skill in the art and so do not present an exhaustive list of alternatives. Moreover, it should be recognized that the stages could be implemented in hardware, firmware, software or any combination thereof.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A computer-implemented method, comprising:
at a mobile device having one or more processors and memory and a display:
receiving an incoming call from a phone number;
in accordance with a determination that the phone number is a harassing phone number, retrieving information associated with the harassing phone number;
after detecting that the incoming call is terminated without being answered, marking the incoming call as a missed call; and
in response to a user request for viewing the missed call, displaying the harassing phone number and at least a portion of the retrieved information adjacent the harassing phone number on the display.

2. The method of claim 1, further comprising:
before retrieving information associated with the harassing phone number:
submitting a query to a remote server, the query including the phone number, wherein the remote sever is configured to determine whether the phone number is a harassing phone number and information associated with the harassing phone number; and
receiving the information associated with the harassing phone number from the remote server.

3. The method of claim 1, wherein the retrieved information includes a number of times that the phone number is marked as a harassing phone number and a nature of the harassing phone number and a website associated with the harassing phone number.

4. The method of claim 1, further comprising:
in response to a user request to visit an entry corresponding to the missed call:
displaying additional information associated with the harassing phone number not displayed before and a plurality of options on the display; and
in response to a user selection of one of the options:
performing an operation associated with the user-selected option.

5. The method of claim 4, further comprising:
in response to a user selection to place a call to the harassing phone number:
initiating the call to the phone number; and
removing the phone number from a list of harassing phone numbers such that no harassing-alert information is displayed in response to future incoming, missed, or outgoing calls associated with the phone number.

6. The method of claim 5, further comprising:
while conducting the call with the phone number:
displaying an option to label the phone number as a harassing phone number on the display; and
in response to a user selection of the option, submitting a request including the phone number to a remote server, wherein the remote server is configured to update a number of times the phone number is marked as a harassing phone number in accordance with the user request.

7. The method of claim 4, further comprising:
in response to a user selection to label the phone number as a harassing phone number:
adding the phone number to a list of harassing phone numbers such that no ringtone is generated in response to future incoming calls from the phone number.

8. A mobile device, comprising:
one or more processors;
memory;
a display; and
one or more programs stored in the memory and to be executed by the one or more processors, the one or more programs comprising instructions for:
receiving an incoming call from a phone number;
in accordance with a determination that the phone number is a harassing phone number, retrieving information associated with the harassing phone number;
after detecting that the incoming call is terminated without being answered, marking the incoming call as a missed call; and
in response to a user request for viewing the missed call, displaying the harassing phone number and at least a portion of the retrieved information adjacent the harassing phone number on the display.

9. The mobile device of claim 8, wherein the one or more programs further include instructions for:
before retrieving information associated with the harassing phone number:
submitting a query to a remote server, the query including the phone number, wherein the remote sever is configured to determine whether the phone number is a harassing phone number and information associated with the harassing phone number; and
receiving the information associated with the harassing phone number from the remote server.

10. The mobile device of claim 8, wherein the retrieved information includes a number of times that the phone number is marked as a harassing phone number and a nature of the harassing phone number and a website associated with the harassing phone number.

11. The mobile device of claim 8, wherein the one or more programs further include instructions for:
in response to a user request to visit an entry corresponding to the missed call:
displaying additional information associated with the harassing phone number not displayed before and a plurality of options on the display; and
in response to a user selection of one of the options:
performing an operation associated with the user-selected option.

12. The mobile device of claim 11, wherein the one or more programs further include instructions for:
in response to a user selection to place a call to the harassing phone number:
initiating the call to the phone number; and
removing the phone number from a list of harassing phone numbers such that no harassing-alert information is displayed in response to future incoming, missed, or outgoing calls associated with the phone number.

13. The mobile device of claim 12, wherein the one or more programs further include instructions for:
while conducting the call with the phone number:
displaying an option to label the phone number as a harassing phone number on the display; and
in response to a user selection of the option, submitting a request including the phone number to a remote server, wherein the remote server is configured to update a number of times the phone number is marked as a harassing phone number in accordance with the user request.

14. The mobile device of claim 11, wherein the one or more programs further include instructions for:
in response to a user selection to label the phone number as a harassing phone number:
adding the phone number to a list of harassing phone numbers such that no ringtone is generated in response to future incoming calls from the phone number.

15. A non-transitory computer readable storage medium storing one or more programs, the one or more programs comprising instructions, which, when executed by a mobile device having one or more processors and a display, cause the mobile device to perform operations including:
receiving an incoming call from a phone number;
in accordance with a determination that the phone number is a harassing phone number, retrieving information associated with the harassing phone number;
after detecting that the incoming call is terminated without being answered, marking the incoming call as a missed call; and
in response to a user request for viewing the missed call, displaying the harassing phone number and at least a portion of the retrieved information adjacent the harassing phone number on the display.

16. The non-transitory computer readable storage medium of claim 15, wherein the operations further include:
before retrieving information associated with the harassing phone number:
submitting a query to a remote server, the query including the phone number, wherein the remote sever is configured to determine whether the phone number is a harassing phone number and information associated with the harassing phone number; and
receiving the information associated with the harassing phone number from the remote server.

17. The non-transitory computer readable storage medium of claim 15, wherein the retrieved information includes a number of times that the phone number is marked as a harassing phone number and a nature of the harassing phone number and a website associated with the harassing phone number.

18. The non-transitory computer readable storage medium of claim 15, wherein the operations further include:
in response to a user request to visit an entry corresponding to the missed call:
displaying additional information associated with the harassing phone number not displayed before and a plurality of options on the display; and
in response to a user selection of one of the options:
performing an operation associated with the user-selected option.

19. The non-transitory computer readable storage medium of claim 18, wherein the operations further include:
in response to a user selection to place a call to the harassing phone number:
initiating the call to the phone number; and
removing the phone number from a list of harassing phone numbers such that no harassing-alert information is displayed in response to future incoming, missed, or outgoing calls associated with the phone number.

20. The non-transitory computer readable storage medium of claim 18, wherein the operations further include:
in response to a user selection to label the phone number as a harassing phone number:
adding the phone number to a list of harassing phone numbers such that no ringtone is generated in response to future incoming calls from the phone number.
